(19) United States
(12) Patent Application Publication
(10) Pub. No.: US 2024/0397660 A1
(43) Pub. Date: Nov. 28, 2024

(54) ELECTRONIC DEVICE INCLUDING DIELECTRIC HEATING DEVICE

(71) Applicant: Samsung Electronics Co., Ltd., Suwon-si (KR)

(72) Inventors: Joonhong KIM, Suwon-si (KR); Youngho RYU, Suwon-si (KR); Daehyun KIM, Suwon-si (KR); Jihoon KIM, Suwon-si (KR); Youngjun PARK, Suwon-si (KR); Kyungmin LEE, Suwon-si (KR); Bohwan CHOI, Suwon-si (KR)

(21) Appl. No.: 18/798,207

(22) Filed: Aug. 8, 2024

Related U.S. Application Data
(63) Continuation of application No. PCT/KR2023/001032, filed on Jan. 20, 2023.

(30) Foreign Application Priority Data
Feb. 15, 2022 (KR) 10-2022-0019581

(51) Int. Cl. H05K 7/20; H05B 6/54

(52) U.S. Cl. CPC H05K 7/20; H05B 6/54

(57) ABSTRACT

An electronic device is provided. The electronic device includes a power source, memory storing one or more computer programs, a dielectric heating device, and one or more processors communicatively coupled to the power source, the memory, and the dielectric heating device, wherein the dielectric heating device includes a first electrode connected to the power source, and a second electrode connected to the power source and arranged to be apart from the first electrode in a direction away from one surface of the first electrode, wherein the second electrode includes a plurality of second unit electrodes arranged at intervals in a longitudinal direction and a width direction, wherein the dielectric heating device heats an object to be heated arranged between the first electrode and the second electrode, and wherein the one or more computer programs include computer-executable instructions that, when executed by the one or more processors individually or collectively, cause the electronic device to determine an electrode distance, which is a linear distance between the first electrode and the second unit electrodes, based on an estimated moisture content value of a partial region of the object being heated arranged on each of the second unit electrodes.

### CROSS-REFERENCE TO RELATED APPLICATION(S)

This application is a continuation application, claiming priority under § 365(c), of an International application No. PCT/KR2023/001032, filed on Jan. 20, 2023, which is based on and claims the benefit of a Korean patent application number 10-2022-0019581, filed on Feb. 15, 2022, in the Korean Intellectual Property Office, the disclosure of which is incorporated by reference herein in its entirety.

### BACKGROUND

### 1. Field

The disclosure relates to an electronic device including a dielectric heating device.

### 2. Description of Related Art

A dielectric heating device is a device that heats an object to be heated that is arranged between two opposite electrodes by applying a high-frequency voltage to the object to be heated. The object to be heated that is arranged in the dielectric heating device may be a dielectric material. The dielectric material may be configured with polar molecules that carry a positive charge at one end and a negative charge at the other end. When the dielectric material is arranged between the two electrodes of the dielectric heating device and an electric field is applied, portions carrying the positive charge of the polar molecules of the dielectric material may be aligned toward a negative electrode and portions carrying the negative charge toward a positive electrode. When the direction of the electric field changes, the polar molecules that are aligned may rotate according to the direction of the electric field, and be realigned. During this realignment process, friction may occur and heat may be generated. The dielectric heating device may heat an entire part of an object by applying a high-frequency voltage, which rapidly and continuously changes the direction of the electric field, increasing frictional heat generated in the process of molecular realignment.

A heating device using a dielectric heating method is widely used in household, medical and industrial applications. For example, a microwave oven, which is used to heat food at home, is a device that operates by the dielectric heating method. The heating device using the dielectric heating method is applied and used not only in the medical field, such as a hyperthermia cancer treatment device and a diathermy device, but also in the industrial field, such as wood drying.

The above information is presented as background information only to assist with an understanding of the disclosure. No determination has been made, and no assertion is made, as to whether any of the above might be applicable as prior art with regard to the disclosure.

### SUMMARY

When an object to be heated is heated using a dielectric heating device according to the related art, the heating may be unevenly performed depending on an internal material composition of the object to be heated. For example, the temperature change of each region of the object to be heated may vary depending on the moisture content that each region of the object to be heated includes. Since regions with relatively more moisture in the object to be heated may require more heat for heating, the temperature change due to heating may be smaller than regions with relatively less moisture. Therefore, a dielectric heating device that may uniformly heat the object to be heated is required even though the moisture content in each region of the object to be heated is not uniform.

Aspects of the disclosure are to address at least the above-mentioned problems and/or disadvantages and to provide at least the advantages described below. Accordingly, an aspect of the disclosure is to provide an electronic device including a dielectric heating device that provides a constitution capable of uniformly heating each region of an object to be heated.

Additional aspects will be set forth in part in the description which follows and, in part, will be apparent from the description, or may be learned by practice of the presented embodiments.

In accordance with an aspect of the disclosure, an electronic device is provided. The electronic device includes a power source, memory storing one or more computer programs, a dielectric heating device, and one or more processors communicatively coupled to the power source, the memory, and the dielectric heating device, wherein the dielectric heating device includes a first electrode connected to the power source, and a second electrode connected to the power source and arranged to be spaced apart from the first electrode in a direction away from one surface of the first electrode, wherein the second electrode includes a plurality of second unit electrodes arranged at intervals in a longitudinal direction and a width direction, wherein the dielectric heating device heats an object to be heated arranged between the first electrode and the second electrode, and wherein the one or more computer programs include computer-executable instructions that, when executed by the one or more processors individually or collectively, cause the electronic device to determine an electrode distance, which is a linear distance between the first electrode and the second unit electrode, based on an estimated moisture content value of a partial region of the object being heated arranged on each of the second unit electrodes.

An electronic device according to an embodiment of the present disclosure may include a power source and a dielectric heating device, in which the dielectric heating device includes a first electrode connected to the power source, and a second electrode connected to the power source and arranged to be spaced apart from the first electrode in a direction away from one surface of the first electrode, and at least a portion of the first electrode may be bent in a direction toward the second electrode.

In accordance with another aspect of the disclosure, a method of operating an electronic device, which includes a dielectric heating device is provided. The method includes activating a plurality of unit electrodes to heat an object to be heated, estimating a moisture content of a partial region of the object to be heated arranged on each of the plurality of unit electrodes, comparing an estimated moisture content value of the partial region of the object to be heated to a reference value, reducing a distance formed by the unit electrode, on which a partial region of the object to be heated with the estimated moisture content value exceeding the reference value is arranged, with a counter electrode when the estimated moisture content value exceeds the reference value in at least one partial region of the object to be heated, and adjusting a distance formed by each of the plurality of unit electrodes with the counter electrode to be equal when the estimated moisture content value in all the partial regions of the object to be heated is equal to or less than the reference value.

An electronic device including a dielectric heating device according to an embodiment of the disclosure includes electrodes that are bent and extend at least in part to enable an object to be heated to be heated evenly.

An electronic device including a dielectric heating device according to an embodiment of the disclosure includes a plurality of unit electrodes that are capable of being adjusted in rotation or distance so that heating is concentrated on a portion of an object to be heated.

An electronic device including a dielectric heating device according to an embodiment of the disclosure estimates a moisture content of each region of an object to be heated so that the object to be heated is evenly heated by a method of heating a region with more moisture relatively strongly.

In accordance with another aspect of the disclosure, one or more non-transitory computer-readable storage media storing computer-executable instructions that, when executed by one or more processors individually or collectively, cause an electronic device, which includes a dielectric heating device, to perform operations are provided. The operations include activating a plurality of unit electrodes to heat an object to be heated, estimating a moisture content of a partial region of the object to be heated arranged on each of the plurality of unit electrodes, comparing an estimated moisture content value of the partial region of the object to be heated to a reference value, reducing a distance formed by the unit electrode, on which a partial region of the object to be heated with the estimated moisture content value exceeding the reference value is arranged, with a counter electrode when the estimated moisture content value exceeds the reference value in at least one partial region of the object to be heated, and adjusting a distance formed by each of the plurality of unit electrodes with the counter electrode to be equal when the estimated moisture content value in all the partial regions of the object to be heated is equal to or less than the reference value.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIGS. 2A and 2B are views illustrating a dielectric heating device that includes a first electrode having a bendable shape according to various embodiments of the disclosure;

FIGS. 3A and 3B are views illustrating a dielectric heating device that includes a second unit electrode that rotates according to various embodiments of the disclosure;

FIGS. 4A and 4B are views illustrating a dielectric heating device that includes a plurality of second unit electrodes that are adjusted in distance from a first electrode, according to various embodiments of the disclosure;

FIG. 5 is a view illustrating a dielectric heating device that includes a plurality of first unit electrodes that are adjusted in distance from a second electrode according to an embodiment of the disclosure;

FIG. 6 is a view illustrating a dielectric heating device that includes a first plate and a second plate according to an embodiment of the disclosure;

FIG. 7 is a view illustrating the first plate according to an embodiment of the disclosure;

FIG. 8 is a view illustrating the second electrode and the second plate according to an embodiment of the disclosure;

FIG. 9 is a view illustrating an electrode moving device according to an embodiment of the disclosure;

FIG. 10 is a flowchart illustrating a method of operating an electronic device that includes a dielectric heating device according to an embodiment of the disclosure;

FIG. 11 is a graph illustrating a reference impedance phase and a measured impedance phase according to an embodiment of the disclosure; and

FIG. 12 is a graph illustrating a reference impedance ratio and a measured impedance ratio according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

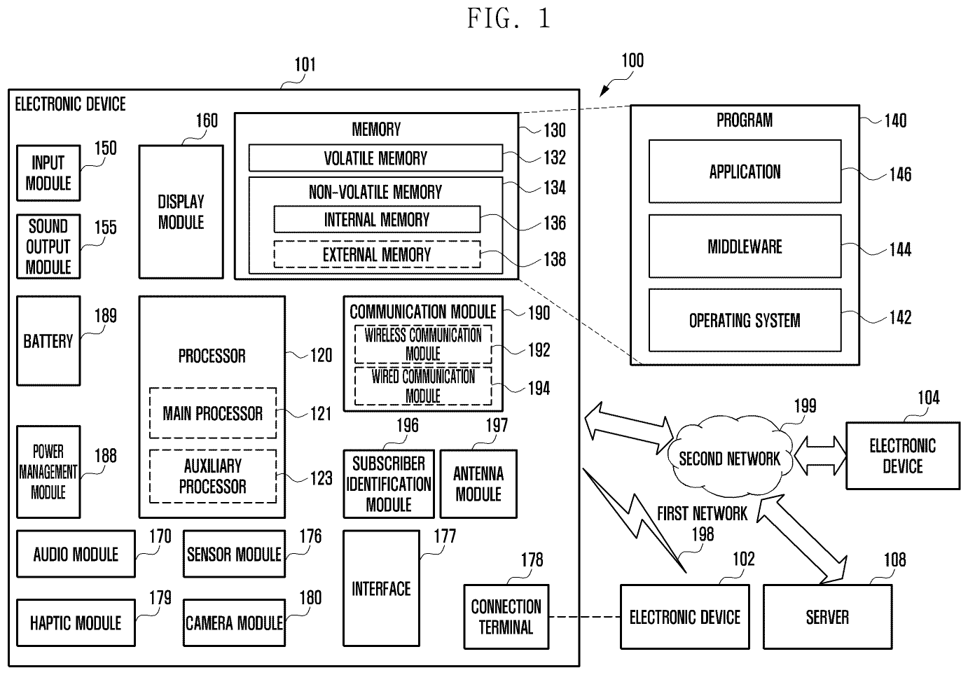

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

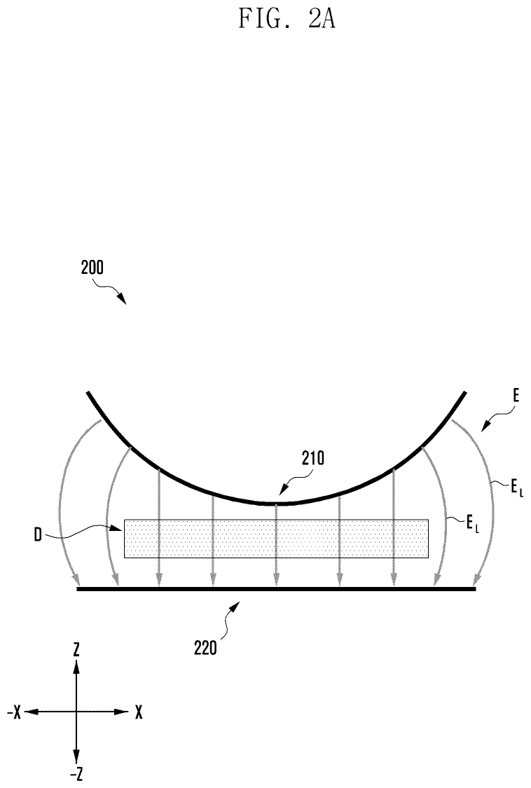

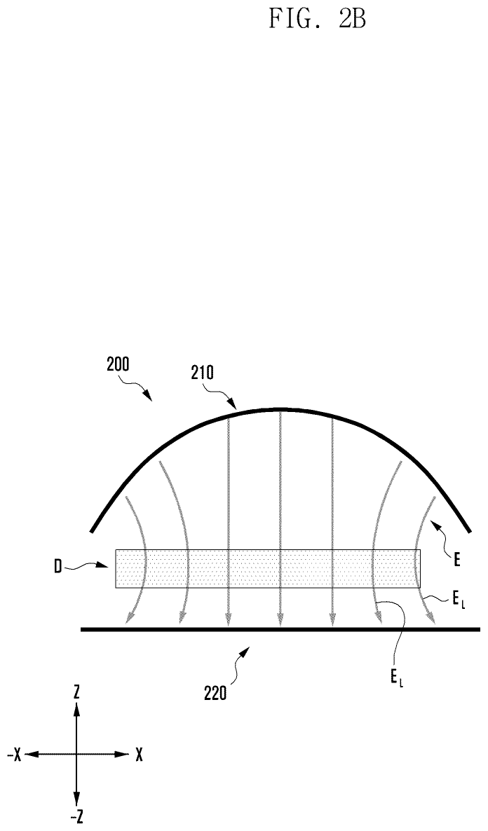

FIG. 2A is a view illustrating a dielectric heating device that includes a first electrode that bends toward a second electrode according to an embodiment of the disclosure.

FIG. 2B is a view illustrating an electrode dielectric heating device that includes a first electrode that bends in an opposite direction of a direction toward the second electrode according to an embodiment of the disclosure.

Referring to FIGS. 2A and 2B, in an embodiment of the disclosure, the electronic device 101 may include the processor 120, a power source (not illustrated), and/or a dielectric heating device 200. The dielectric heating device 200 may heat an object D to be heated that is arranged in the dielectric heating device 200 using a dielectric heating method.

In an embodiment of the disclosure, the power source (not illustrated) may supply alternating current power to the dielectric heating device 200. The power source (not illustrated) may be connected to a first electrode 210 and a second electrode 220 of the dielectric heating device 200 to supply alternating current power.

In an embodiment of the disclosure, the power source (not illustrated) may include a battery (189, see FIG. 1) and/or a conversion device (not illustrated) (e.g., an inverter). The conversion device (not illustrated) (e.g., an inverter) may convert a direct current voltage generated from the battery (189, see FIG. 1) to alternating current.

In an embodiment of the disclosure, the processor 120 may control the dielectric heating device 200.

In an embodiment of the disclosure, with the dielectric heating method, the object D to be heated may be heated by arranging the object D to be heated, which is a dielectric material, between two opposite electrodes and applying a high frequency voltage to the object D to be heated. The object D to be heated which is subject to dielectric heating may include polar molecules. The directions of the polar molecules may be affected by an electric field. When the object D to be heated is exposed to an electric field that changes over time, the polar molecules that constitute the object D to be heated may change directions and vibrate with the changes in the electric field.

In an embodiment of the disclosure, when a frequency of a voltage applied to the dielectric heating device 200 increases, the polar molecules may not be arranged in a direction that perfectly matches the vibrating electric field, which results in a phase lag. Energy from the electric field is absorbed into the object D to be heated due to the phase lag and may be dissipated as heat. The dielectric heating device 200 may be a device for heating the object D to be heated using heat generated through this process.

In an embodiment of the disclosure, magnitude of power P generated through the dielectric heating device 200 may be determined by an operating frequency of the dielectric heating device 200, characteristics of the object D to be heated, and intensity of the electric field. For example, the power P generated through the dielectric heating device 200 may be calculated using Equation 1. The frequency (f) may mean an operating frequency of the dielectric heating device 200. εₒ may mean permittivity in a vacuum state. ε″ may mean a relative dielectric loss factor determined according to the characteristics of the object D to be heated. E may mean intensity of an electric field generated by alternating current power supplied to the dielectric heating device 200.

P=2πfε₀ε″|E|² Equation 1

When a heating method of the related art is used to heat the object D to be heated, a heat source may be positioned on the outside of the object D to be heated. The heating method of the related art may be a heating method in which thermal energy generated from an external heat source is transferred from a higher temperature region to a lower temperature region of the object D to be heated. In the heating method of the related art, the object D to be heated may be heated unevenly according to a thermal conduction gradient, and a heating rate may be relatively slow.

Unlike the heating method of the related art, the dielectric heating method forms an electric field to directly affect the molecules constituting the object D to be heated, resulting in a relatively uniform heating of the object D to be heated. In the dielectric heating method, a heating efficiency may vary according to the electrical characteristics of the object D to be heated.

The dielectric heating device 200 may be a device that arranges the object D to be heated between two opposite electrodes and applies a high frequency voltage to heat the object D to be heated. The object D to be heated that is arranged in the dielectric heating device 200 may be a dielectric material. The dielectric material may be constituted of polar molecules (dipoles) that carry a positive charge at one end and a negative charge at the other end. The polar molecule constituting the dielectric material may change in arrangement depending on the direction of the electric field formed in the dielectric heating device 200. For example, when the first electrode 210 of the dielectric heating device 200 carries a positive charge, the negative charge of the polar molecule may be arranged in a direction toward the first electrode 210. When the second electrode 220 of the dielectric heating device 200 carries a negative charge, the positive charge of the polar molecule may be arranged in a direction toward the second electrode 220.

In describing the dielectric heating device 200 according to an embodiment of the disclosure, a longitudinal direction of the dielectric heating device 200 may mean a positive x-axis direction. A height direction of the dielectric heating device 200 may mean a positive z-axis direction. A width direction of the dielectric heating device 200 may mean a direction perpendicular to the x-axis direction and the z-axis direction.

The dielectric heating device 200 according to an embodiment of the disclosure may include the first electrode 210 and/or the second electrode 220.

In an embodiment of the disclosure, the first electrode 210 and the second electrode 220 may extend in the longitudinal direction of the dielectric heating device 200 (e.g., in the positive x-axis direction). The first electrode 210 and the second electrode 220 may extend in the width direction of the dielectric heating device 200 (e.g., in the direction perpendicular to the x- and z-axes).

In an embodiment of the disclosure, the second electrode 220 may be arranged spaced apart from the first electrode 210 in a direction away from one surface of the first electrode 210. For example, the first electrode 210 may be arranged spaced apart from the second electrode 220 in the height direction of the dielectric heating device 200 (e.g., in the positive z-axis direction).

In an embodiment of the disclosure, the object D to be heated may be arranged between the first electrode 210 and the second electrode 220. For example, the object D to be heated may be arranged on one surface of the second electrode 220 (e.g., a surface of the second electrode 220 that faces the first electrode 210).

In an embodiment of the disclosure, the object D to be heated may be a dielectric material. The dielectric material may mean an insulator that becomes polarized in an electric field E.

Referring to FIG. 2A, the electric field E may be represented by a plurality of electric lines of force E_{L}. The plurality of electric lines of force E_{L} may be formed in a direction from a positive charge toward a negative charge. For example, when the first electrode 210 carries a positive charge and the second electrode 220 carries a negative charge, the plurality of electric lines of force E_{L} may be formed in a direction from the first electrode 210 toward the second electrode 220.

In an embodiment of the disclosure, a center point of the first electrode 210 may mean a point positioned at a center of the first electrode 210 with respect to the longitudinal direction of the dielectric heating device 200 (e.g., the positive x-axis direction). One end and the other end of the first electrode 210 may mean the ends of the first electrode 210 with respect to the longitudinal direction of the dielectric heating device 200 (e.g., the positive x-axis direction).

At least a portion of the first electrode 210 of the dielectric heating device 200, according to an embodiment of the disclosure, may be bent in a direction toward the second electrode 220. For example, referring to FIG. 2A, the first electrode 210 may be bent such that the center point of the first electrode 210 is closer to the second electrode 220 than one end and the other end of the first electrode 210.

When at least a portion of the first electrode 210 is bent and extends in a direction toward the second electrode 220, the electric line of force EL may be more evenly distributed across the entire object D to be heated compared to when the first electrode 210 is not bent and extends. For example, when the first electrode 210 is not bent and extends, the electric line of force E_{L} may be focused on one end and the other end of the object D to be heated, but when at least a portion of the first electrode 210 is bent in a direction toward the second electrode 220, the electric line of force E_{L} may be prevented from being focused on one end and the other end of the object D to be heated.

Referring to FIG. 2A, the first electrode 210 may be bent and extend so that at least a portion of the electric line of force EL positioned at one end of the object D to be heated (e.g., an end facing the positive x-axis direction) is formed in a bent shape in the longitudinal direction (e.g., the positive x-axis direction) of the dielectric heating device 200. At least a portion of the electric line of force E_{L} positioned at the other end of the object D to be heated (e.g., the end facing the negative x-axis direction) may be formed in a bent shape in a direction opposite to the longitudinal direction of the dielectric heating device 200 (e.g., the negative x-axis direction). At least a portion of the electric line of force E_{L} is formed in a bent shape, and the electric line of force E_{L} may be prevented from being concentrated on one end and the other end of the object D to be heated.

At least a portion of the first electrode 210 of the dielectric heating device 200, according to an embodiment of the disclosure, may be bent in a direction opposite to the direction toward the second electrode 220 (e.g., in the positive z-axis direction). For example, referring to FIG. 2B, the first electrode 210 may be bent such that the center point of the first electrode 210 is farther from the second electrode 220 than one end and the other end of the first electrode 210.

In an embodiment of the disclosure, when at least a portion of the first electrode 210 is bent in the direction opposite to the direction toward the second electrode 220, the leakage of the electric field E may be reduced. For example, referring to FIG. 2B, the electric line of force E_{L} formed at one end of the object D to be heated (e.g., an end facing the positive x-axis direction of the object D to be heated) may be bent and formed in a direction opposite to the longitudinal direction of the dielectric heating device 200 (e.g., the negative x-axis direction). The electric line of force E_{L} formed at the other end of the object D to be heated (e.g., an end facing a negative x-axis direction of the object D to be heated) may be bent and formed in the longitudinal direction of the dielectric heating device 200 (e.g., the positive x-axis direction). Since the electric line of force E_{L} formed at one end and the other end of the object D to be heated is bent in a direction toward the object D to be heated, the electric line of force E_{L} leaving the object D to be heated is reduced, and the leakage of the electric field E may be reduced.

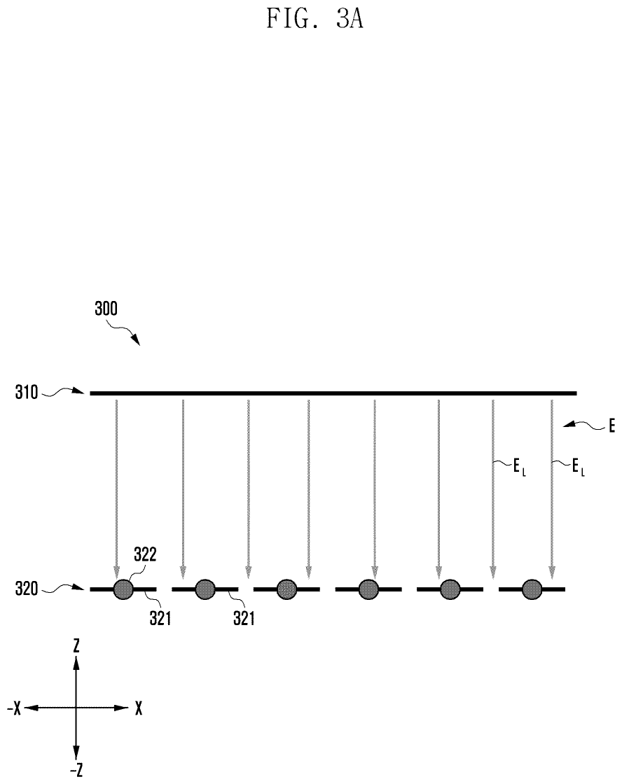

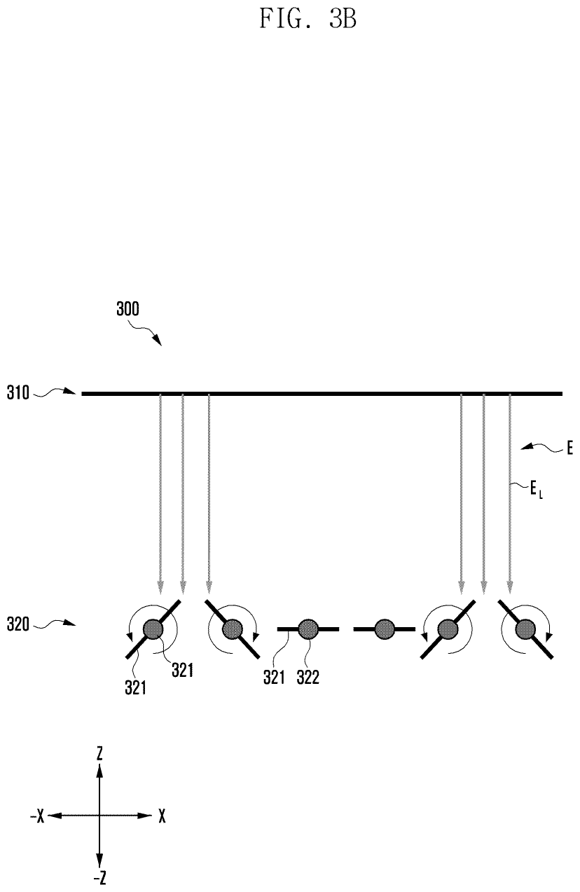

FIG. 3A is a view illustrating a dielectric heating device 300 that includes a second unit electrode 321 that is rotatable about a center of rotation 322, according to an embodiment of the disclosure.

FIG. 3B is a view illustrating the dielectric heating device 300 that includes the second unit electrode 321 rotating about the center of rotation 322, according to an embodiment of the disclosure.

In an embodiment of the disclosure, the electronic device 101 may include the processor 120, a power source (not illustrated), and/or the dielectric heating device 300. The dielectric heating device 300 may heat an object D to be heated (see FIG. 2A) that is arranged in the dielectric heating device 300 using a dielectric heating method.

In an embodiment of the disclosure, the power source (not illustrated) may supply alternating current power to the dielectric heating device 300. The power source (not illustrated) may be connected to a first electrode 310 and a second electrode 320 of the dielectric heating device 300 to supply alternating current power.

In an embodiment of the disclosure, the power source (not illustrated) may include a battery (189, see FIG. 1) and/or a conversion device (not illustrated) (e.g., an inverter). The conversion device (not illustrated) (e.g., an inverter) may convert a direct current voltage generated from the battery (189, see FIG. 1) to alternating current.

In an embodiment of the disclosure, the processor 120 may control the dielectric heating device 300.

In describing the dielectric heating device 300 according to an embodiment of the disclosure, a longitudinal direction of the dielectric heating device 300 may mean a positive x-axis direction. A height direction of the dielectric heating device 300 may mean a positive z-axis direction. A width direction of the dielectric heating device 300 may mean a direction perpendicular to the x-axis direction and the z-axis direction.

The dielectric heating device 300 according to an embodiment of the disclosure may include the first electrode 310 and/or the second electrode 320.

In an embodiment of the disclosure, the second electrode 320 may include a plurality of second unit electrodes 321. Referring to FIGS. 3A and 3B, the second electrode 320 includes six second unit electrodes 321, but the number of second unit electrodes 321 may not be limited thereto.

In an embodiment of the disclosure, the plurality of second unit electrodes 321 may be arranged at intervals in a longitudinal direction of the dielectric heating device 300 (e.g., in the positive x-axis direction). The plurality of second unit electrodes 321 may be arranged at intervals in a width direction of the dielectric heating device 300.

In an embodiment of the disclosure, the plurality of second unit electrodes 321 may include the center of rotation 322. The center of rotation 322 may mean a point positioned at a center of the second unit electrode 321 in a longitudinal direction of the second unit electrode 321 (e.g., in the positive x-axis direction).

In an embodiment of the disclosure, each of the plurality of second unit electrodes 321 may rotate about the center of rotation 322 in a clockwise direction (e.g., a direction of rotation from a positive x-axis toward a positive z-axis) or in a counterclockwise direction.

In an embodiment of the disclosure, the intensity of the electric field E formed in the dielectric heating device 300 may vary depending on a distance between the first electrode 310 and the second electrode 320. For example, the intensity of the electric field E may increase when the distance between the first electrode 310 and the second electrode 320 decreases.

In an embodiment of the disclosure, at least some of the second unit electrodes 321 rotate, and the distribution of the electric field E between the first electrode 310 and the second electrode 320 may vary. Referring to FIG. 3B, some of the plurality of second unit electrodes 321 may rotate in a clockwise or counterclockwise direction, resulting in a relatively close distance to the first electrode 310. For example, the second unit electrode 321 that has rotated may be formed such that the distance from the first electrode 310 is relatively closer than the second unit electrode 321 that has not rotated. The intensity of the electric field E may be formed relatively stronger at the second unit electrode 321 that is closer in distance from the first electrode 310.

The electronic device 101 according to an embodiment of the disclosure may, under the control of the processor 120, allow the second unit electrode 321 that is in close proximity to a region of the object D to be heated (see FIG. 2A) where heating needs to be concentrated to rotate in a clockwise or counterclockwise direction. The electronic device 101 may, under the control of the processor 120, allow the second unit electrode 321, which is arranged in close proximity to the region of the object D to be heated (see FIG. 2A) where the heating needs to be concentrated, to rotate in a clockwise or counterclockwise direction to cause the distance from the first electrode 310 to be relatively closer.

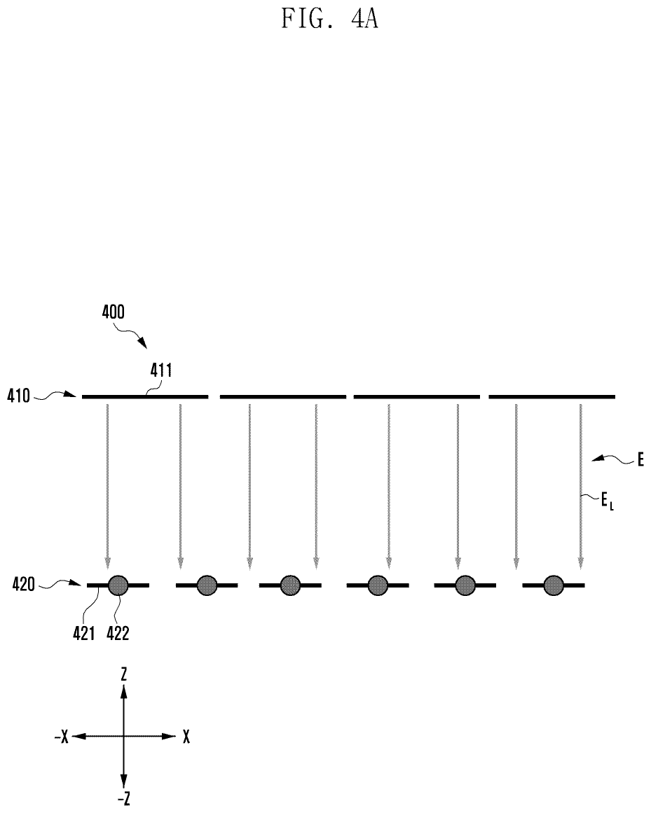

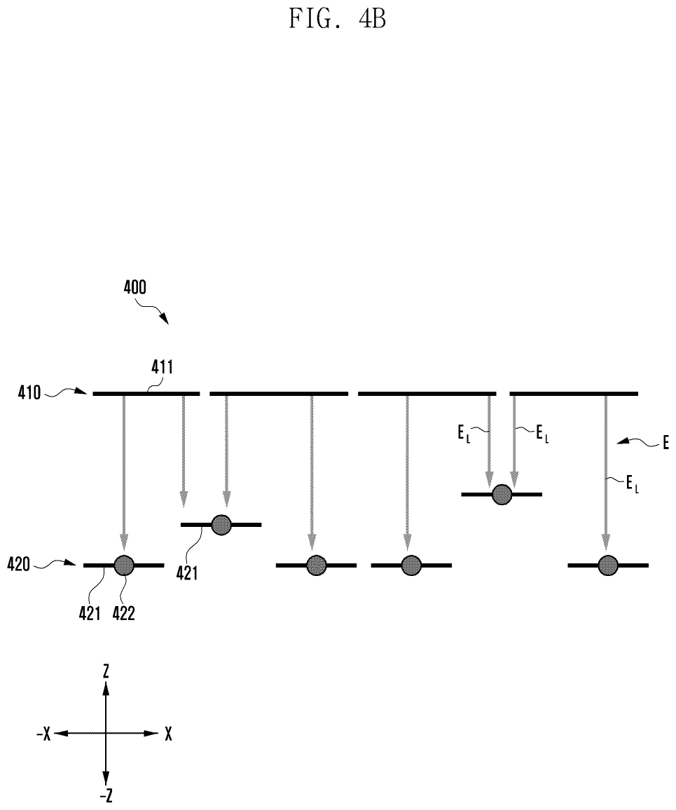

FIG. 4A is a view illustrating a dielectric heating device 400 that includes a plurality of second unit electrodes 421 that is rotatable about a center of rotation 422, according to an embodiment of the disclosure.

FIG. 4B is a view illustrating the dielectric heating device 400 that includes the plurality of second unit electrodes 421 that are adjusted in distance from a first electrode 410, according to an embodiment of the disclosure.

In an embodiment of the disclosure, the electronic device 101 may include the processor 120, a power source (not illustrated), and/or the dielectric heating device 400. The dielectric heating device 400 may heat an object D to be heated (see FIG. 2A) that is arranged in the dielectric heating device 400 using a dielectric heating method.

In an embodiment of the disclosure, the power source (not illustrated) may supply alternating current power to the dielectric heating device 400. The power source (not illustrated) may be connected to the first electrode 410 and a second electrode 420 of the dielectric heating device 400 to supply alternating current power.

In an embodiment of the disclosure, the power source (not illustrated) may include a battery (189, see FIG. 1) and/or a conversion device (not illustrated) (e.g., an inverter). The conversion device (not illustrated) (e.g., an inverter) may convert a direct current voltage generated from the battery (189, see FIG. 1) to alternating current.

In an embodiment of the disclosure, the processor 120 may control the dielectric heating device 400.

In describing the dielectric heating device 400 according to an embodiment of the disclosure, a longitudinal direction of the dielectric heating device 400 may mean a positive x-axis direction. A height direction of the dielectric heating device 400 may mean a positive z-axis direction. A width direction of the dielectric heating device 400 may mean a direction perpendicular to the x-axis direction and the z-axis direction.

The dielectric heating device 400 according to an embodiment of the disclosure may include the first electrode 410 and/or the second electrode 420.

In an embodiment of the disclosure, the first electrode 410 may include a plurality of first unit electrodes 411. Referring to FIGS. 4A and 4B, the first electrode 410 includes four first unit electrodes 411, but the number of first unit electrodes 411 may not be limited thereto.

In an embodiment of the disclosure, the plurality of first unit electrodes 411 may be arranged at intervals in a longitudinal direction of the dielectric heating device 400 (e.g., in the positive x-axis direction). The plurality of first unit electrodes 411 may be arranged at intervals in a width direction of the dielectric heating device 400.

In an embodiment of the disclosure, the second electrode 420 may include a plurality of second unit electrodes 421. Referring to FIGS. 4A and 4B, the second electrode 420 includes six second unit electrodes 421, but the number of second unit electrodes 421 may not be limited thereto.

In an embodiment of the disclosure, the plurality of second unit electrodes 421 may be arranged at intervals in a longitudinal direction of the dielectric heating device 400 (e.g., in the positive x-axis direction). The plurality of second unit electrodes 421 may be arranged at intervals in a width direction of the dielectric heating device 400.

In an embodiment of the disclosure, each of the plurality of second unit electrodes 421 may move in a direction toward the first electrode 410 (e.g., in the positive z-axis direction), or may move in a direction opposite to the direction toward the first electrode 410 (e.g., in the negative z-axis direction). The second unit electrode 421 may move in the direction toward the first electrode 410 so that a distance between the second unit electrode 421 and the first electrode 410 may be reduced.

In an embodiment of the disclosure, at least some of the second unit electrodes 421 move in the direction toward the first electrode 410 of the dielectric heating device 400 (e.g., in the positive z-axis direction), and the distribution of the electric field E between the first electrode 410 and the second electrode 420 may vary. Referring to FIG. 4B, some of the plurality of second unit electrodes 421 may move in the direction toward the first electrode 410 and be relatively closer in distance to the first electrode 410 compared to the remaining second unit electrodes 421. The second unit electrode 421 that has moved in the direction toward the first electrode 410 may form a relatively close distance from the first electrode 410 compared to the remaining second unit electrodes 421 that have not moved. Since the intensity of the electric field E may be inversely proportional to the distance between the first electrode 410 and the second electrode 420, the intensity of the electric field E formed between the second unit electrode 421 that is closer in distance from the first electrode 410 and the first electrode 410 may be relatively stronger than the intensity of the electric field E formed at the remaining second unit electrodes 421.

The electronic device 101 according to an embodiment of the disclosure may, under control of the processor 120, allow the second unit electrode 421, which is in close proximity to a region of the object D to be heated (see FIG. 2A) where heating needs to be concentrated, to move in the direction toward the first electrode 410 (e.g., in the positive z-axis direction).

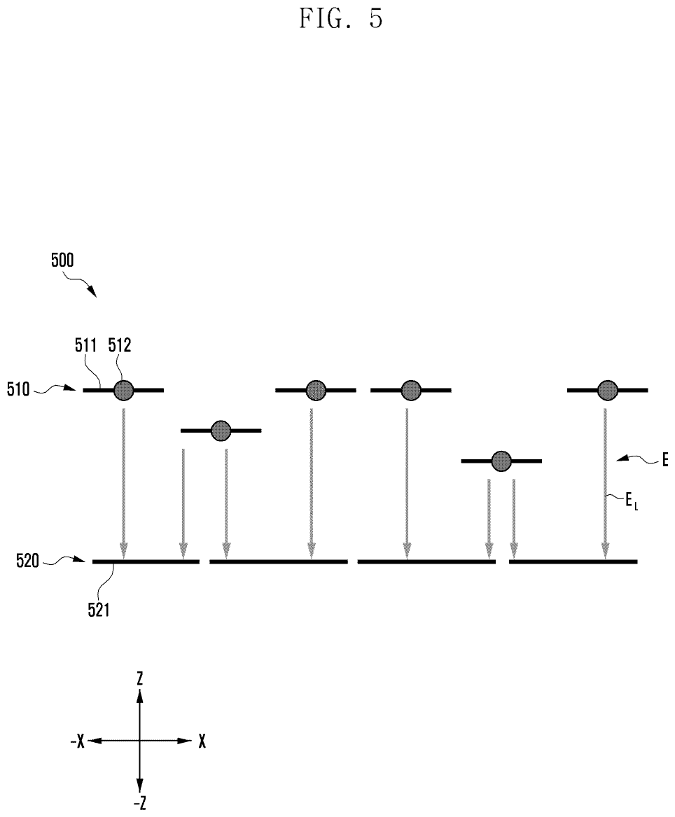

FIG. 5 is a view illustrating a dielectric heating device 500 that includes a plurality of first unit electrodes 511 that are adjusted in distance from a second electrode 520, according to an embodiment of the disclosure.

In an embodiment of the disclosure, the electronic device 101 may include the processor 120, a power source (not illustrated), and/or the dielectric heating device 500. The dielectric heating device 500 may heat an object D to be heated (see FIG. 2A) that is arranged in the dielectric heating device 500 using a dielectric heating method.

In an embodiment of the disclosure, the power source (not illustrated) may supply alternating current power to the dielectric heating device 500. The power source (not illustrated) may be connected to a first electrode 510 and the second electrode 520 of the dielectric heating device 500 to supply alternating current power.

In an embodiment of the disclosure, the power source (not illustrated) may include a battery (189, see FIG. 1) and/or a conversion device (not illustrated) (e.g., an inverter). The conversion device (not illustrated) (e.g., an inverter) may convert a direct current voltage generated from the battery (189, see FIG. 1) to alternating current.

In an embodiment of the disclosure, the processor 120 may control the dielectric heating device 500.

In describing the dielectric heating device 500 according to an embodiment of the disclosure, a longitudinal direction of the dielectric heating device 500 may mean a positive x-axis direction. A height direction of the dielectric heating device 500 may mean a positive z-axis direction. A width direction of the dielectric heating device 500 may mean a direction perpendicular to the x-axis direction and the z-axis direction.

In an embodiment of the disclosure, the first electrode 510 may include the plurality of first unit electrodes 511. Referring to FIG. 5, the first electrode 510 includes six first unit electrodes 511, but the number of first unit electrodes 511 may not be limited thereto.

In an embodiment of the disclosure, the second electrode 520 may include a plurality of second unit electrodes 521.

In an embodiment of the disclosure, the plurality of first unit electrodes 511 may be arranged at intervals in a longitudinal direction of the dielectric heating device 500 (e.g., in the positive x-axis direction). The plurality of first unit electrodes 511 may be arranged at intervals in a width direction of the dielectric heating device 500.

In an embodiment of the disclosure, each of the plurality of first unit electrodes 511 may move in a direction toward the second electrode 520 of the dielectric heating device 500 (e.g., in the negative z-axis direction), or may move in a direction opposite to the direction toward the second electrode 520 (e.g., in the positive z-axis direction).

In an embodiment of the disclosure, the first unit electrode 511 may move in the direction toward the second electrode 520 (e.g., in the negative z-axis direction) so that a distance between the first unit electrode 511 and the second electrode 520 may be reduced.

In an embodiment of the disclosure, the first unit electrode 511 moves in the direction toward the second electrode 520, and the distribution of the electric field E between the first electrode 510 and the second electrode 520 may vary. Referring to FIG. 5, some of the plurality of first unit electrodes 511 may move in the direction toward the second electrode 520, and be relatively closer in distance from the second electrode 520 compared to the remaining first unit electrodes 511. The intensity of the electric field E formed on the first unit electrode 511 that is relatively close in distance from the second electrode 520 may be relatively stronger compared to the intensity of the electric field E formed on the remaining first unit electrodes 511.

The electronic device 101 according to an embodiment of the disclosure may, under control of the processor 120, allow the first unit electrode 511, which is in close proximity to a region of the object D to be heated (see FIG. 2A) where heating needs to be concentrated, to move in the direction toward the second electrode 520 (e.g., in the negative z-axis direction).

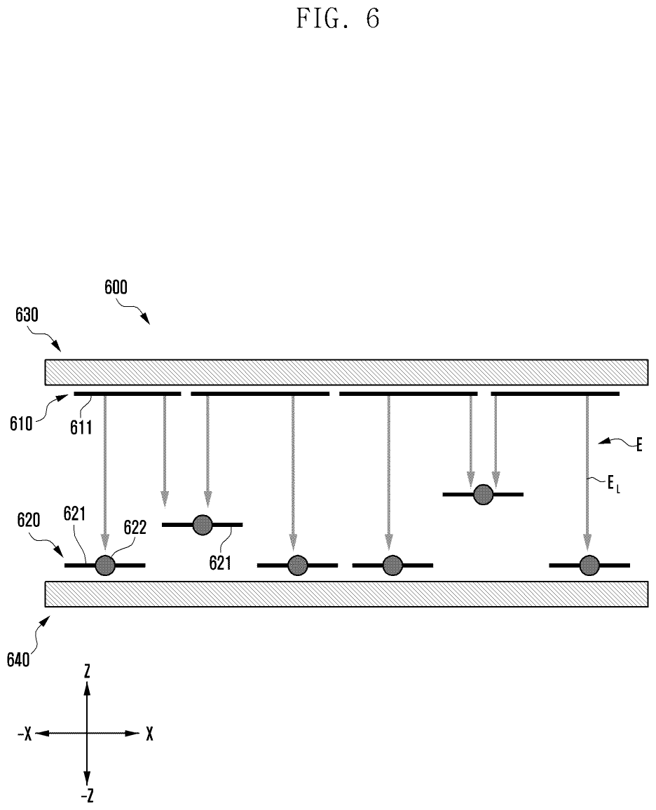

FIG. 6 is a view illustrating a dielectric heating device 600 that includes a first plate 630 and a second plate 640 according to an embodiment of the disclosure.

In an embodiment of the disclosure, the electronic device 101 may include the processor 120, a power source (not illustrated), and/or the dielectric heating device 600. The dielectric heating device 600 may heat an object D to be heated (see FIG. 2A) that is arranged in the dielectric heating device 600 using a dielectric heating method.

In an embodiment of the disclosure, the power source (not illustrated) may supply alternating current power to the dielectric heating device 600. The power source (not illustrated) may be connected to a first electrode 610 and a second electrode 620 of the dielectric heating device 600 to supply alternating current power.

In an embodiment of the disclosure, the power source (not illustrated) may include a battery (189, see FIG. 1) and/or a conversion device (not illustrated) (e.g., an inverter). The conversion device (not illustrated) (e.g., an inverter) may convert a direct current voltage generated from the battery (189, see FIG. 1) to alternating current.

In an embodiment of the disclosure, the processor 120 may control the dielectric heating device 600.

In describing the dielectric heating device 600 according to an embodiment of the disclosure, a longitudinal direction of the dielectric heating device 600 may mean a positive x-axis direction. A height direction of the dielectric heating device 600 may mean a positive z-axis direction. A width direction of the dielectric heating device 600 may mean a direction perpendicular to the x-axis direction and the z-axis direction.

The dielectric heating device 600 according to an embodiment of the disclosure may include the first electrode 610, the second electrode 620, the first plate 630, and/or the second plate 640.

In an embodiment of the disclosure, the first electrode 610 may include a plurality of first unit electrodes 611. The plurality of first unit electrodes 611 may be arranged at intervals in a longitudinal direction of the dielectric heating device 600 (e.g., in the positive x-axis direction). The plurality of first unit electrodes 611 may be arranged at intervals in a width direction of the dielectric heating device 600.

In an embodiment of the disclosure, the second electrode 620 may include a plurality of second unit electrodes 621. The plurality of second unit electrodes 621 may be arranged at intervals in a longitudinal direction of the dielectric heating device 600 (e.g., in the positive x-axis direction). The plurality of second unit electrodes 621 may be arranged at intervals in a width direction of the dielectric heating device 600.

In an embodiment of the disclosure, the first plate 630 may be arranged in a height direction (e.g., in the positive z-axis direction) of the dielectric heating device 600 with respect to the first electrode 610. For example, the plurality of first unit electrodes 611 may be arranged on one surface of the first plate 630 (e.g., a surface facing the negative z-axis direction).

In an embodiment of the disclosure, the second plate 640 may be arranged in a direction opposite to the height direction of the dielectric heating device 600 (e.g., in the negative z-axis direction) with respect to the second electrode 620. For example, the plurality of second unit electrodes 621 may be arranged on one surface of the second plate 640 (e.g., a surface facing in the positive z-axis direction).

In an embodiment of the disclosure, the first plate 630 and the second plate 640 may serve to support the first unit electrode 611 and the second unit electrode 621 so that the first unit electrode 611 and the second unit electrode 621 each maintain a predetermined position. For example, the second unit electrode 621 may be arranged on one surface of the second plate 640, supported by the second plate 640, and maintained in a predetermined position.

In an embodiment of the disclosure, each of the plurality of second unit electrodes 621 may move in a direction toward the first electrode 610 of the dielectric heating device 600 (e.g., in the positive z-axis direction), or may move in a direction opposite to the direction toward the first electrode 610 (e.g., in the negative z-axis direction).

The electronic device 101 according to an embodiment of the disclosure may, under control of the processor 120, allow the second unit electrode 621, which is in close proximity to a region of the object D to be heated (see FIG. 2A) where heating needs to be concentrated, to move in the direction toward the first electrode 610 (e.g., in the positive z-axis direction).

In an embodiment of the disclosure, each of the plurality of second unit electrodes 621 may include a center of rotation 622. Each of the plurality of second unit electrodes 621 may rotate about the center of rotation 622 in a clockwise or counterclockwise direction.

In an embodiment of the disclosure, the electronic device 101 may, under the control of the processor 120, allow the second unit electrode 621, which is arranged in close proximity to the region of the object D to be heated (see FIG. 2A) where heating needs to be concentrated, to rotate in a clockwise or counterclockwise direction to cause the distance from the first electrode 610 to be relatively closer.

In an embodiment of the disclosure, the electronic device 101 may include an impedance matcher (not illustrated). The impedance matcher (not illustrated) may be arranged between the power source and the electrodes 610 and 620 to serve to reduce a difference between an output impedance of the power source and an impedance of the electrodes 610 and 620.

In an embodiment of the disclosure, the first electrode 610 and/or the second electrode 620 may include a metal (e.g., aluminum, iron).

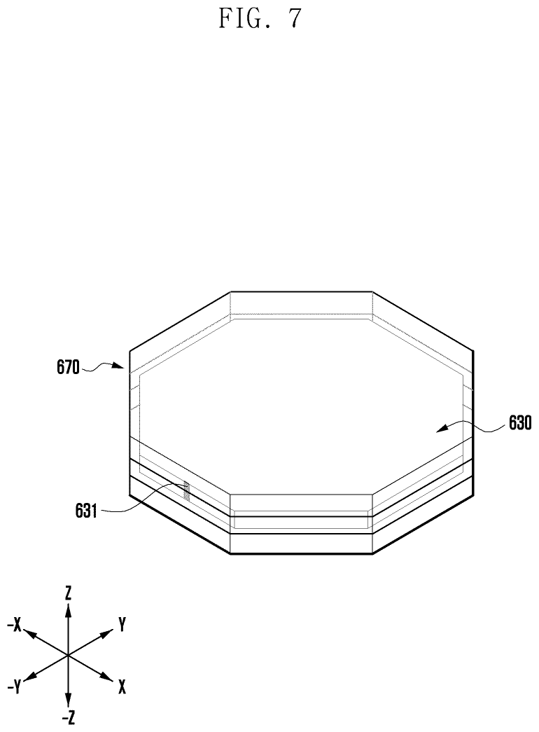

FIG. 7 is a view illustrating the first plate 630 according to an embodiment of the disclosure.

In an embodiment of the disclosure, the first plate 630 may include a cross-section of a polygonal shape. For example, the first plate 630 may have a cross-section of octagonal shape in the x-y plane. The first plate 630 may be formed with a height in the positive z-axis direction.

While FIG. 7 illustrates that the first plate 630 includes a cross-section of octagonal shape, this is just provided for illustration only, and the cross-sectional shape of the first plate 630 may not be limited thereto.

In an embodiment of the disclosure, the second plate 640 (see FIG. 6) may include a cross-section of a polygonal shape. For example, the second plate 640 (see FIG. 6) may have a cross-section of octagonal shape in the x-y plane, and may be formed with a height in the positive z-axis direction.

In an embodiment of the disclosure, the first plate 630 may include, at least in part, a first power feeding part 631. The power source (not illustrated) may be connected to the first power feeding part 631 of the first plate 630 to supply voltage to the first plate 630.

In an embodiment of the disclosure, the second plate 640 (see FIG. 6) may include, at least in part, a second power feeding part (not illustrated). The power source (not illustrated) may be connected to the second power feeding part (not illustrated) of the second plate 640 (see FIG. 6) to supply voltage to the second plate 640 (see FIG. 6).

In an embodiment of the disclosure, the dielectric heating device 600 (see FIG. 6) may include a shielding member 670. FIG. 7 illustrates the shielding member 670 that externally surrounds the first plate 630. While FIG. 7 illustrates that the shielding member 670 surrounds the first plate 630 only, the arrangement of the shielding member 670 is not limited thereto. For example, the shielding member 670 may be arranged to externally surround the first electrode 610 (see FIG. 6), the second electrode 620 (see FIG. 6), the first plate 630, and/or the second plate 640 (see FIG. 6).

In an embodiment of the disclosure, the shielding member 670 may have the same shape as the shape of the first plate 630. For example, when the first plate 630 is formed with a cross-section of an octagonal shape in the x-y plane and a height in the positive z-axis direction, the shielding member 670 may be arranged to externally surround the first plate 630 and be formed with a cross-section of an octagonal shape in the x-y plane and a height in the positive z-axis direction.

In an embodiment of the disclosure, the shielding member 670 may block electromagnetic waves generated from the dielectric heating device 600 (see FIG. 6) from being exposed to the outside. For example, the dielectric heating device 600 (see FIG. 6) may radiate an electromagnetic interference (EMI) noise to the outside, which may interfere with the normal operation of the electronic devices positioned outside. The shielding member 670 may serve to block the electromagnetic interference noise radiated from the dielectric heating device 600 (see FIG. 6).

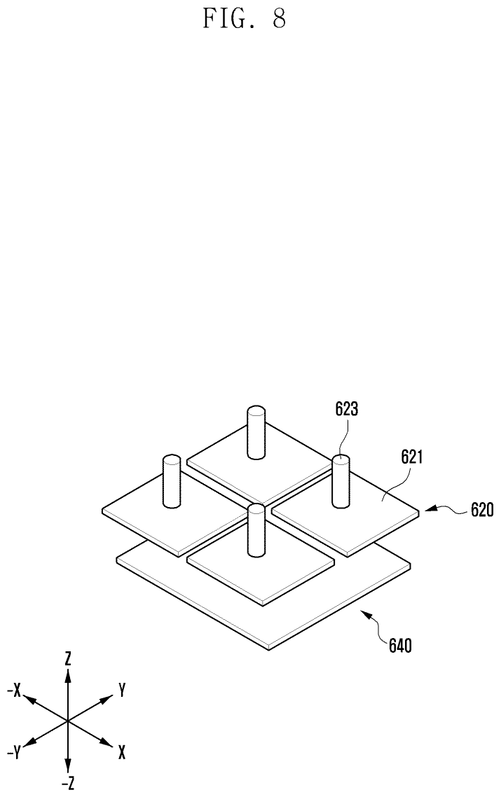

FIG. 8 is a view illustrating the second electrode 620 and the second plate 640 according to an embodiment of the disclosure.

In describing the second electrode 620 according to an embodiment of the disclosure, a longitudinal direction of the second electrode 620 may mean the positive x-axis direction, and a wide direction of the second electrode 620 may mean the positive y-axis direction. A height direction of the second electrode 620 may mean the positive z-axis direction.

Referring to FIG. 8, the second electrode 620 may include the plurality of second unit electrodes 621. The plurality of second unit electrodes 621 may be each arranged at intervals in the longitudinal direction (e.g., the positive x-axis direction) and the width direction (e.g., the positive y-axis direction) of the second electrode 620.

In an embodiment of the disclosure, the plurality of second unit electrodes 621 may be arranged on one surface of the second plate 640 (e.g., a surface facing the height direction of the second plate 640). The second plate 640 may support the plurality of second unit electrodes 621.

In an embodiment of the disclosure, each of the plurality of second unit electrodes 621 may include a protrusion 623. The protrusion 623 may have a cylindrical shape and extend in the height direction of the second electrode 620 (e.g., in the positive z-axis direction).

In an embodiment of the disclosure, the protrusion 623 may include a sensor (not illustrated). The sensor (not illustrated) may measure the moisture content of the object D to be heated (see FIG. 2A) arranged between the second unit electrode 621 and the first electrode 610 (see FIG. 6).

In an embodiment of the disclosure, each of the plurality of second unit electrodes 621 may move in the height direction of the second electrode 620 (e.g., in the positive z-axis direction) and in a direction opposite to the height direction.

In an embodiment of the disclosure, each of the plurality of second unit electrodes 621 may be connected to a single motor (not illustrated). The motor (not illustrated) may serve to move each of the second unit electrodes 621 in the height direction of the second electrode 620 and in the direction opposite to the height direction.

In an embodiment of the disclosure, the plurality of second unit electrodes 621 may be simultaneously connected to a single motor (not illustrated). For example, four second unit electrodes 621 may be connected to a single motor (not illustrated). The motor (not illustrated) may serve to move the plurality of second unit electrodes 621 at once in the height direction of the second electrode 620 and in the direction opposite to the height direction.

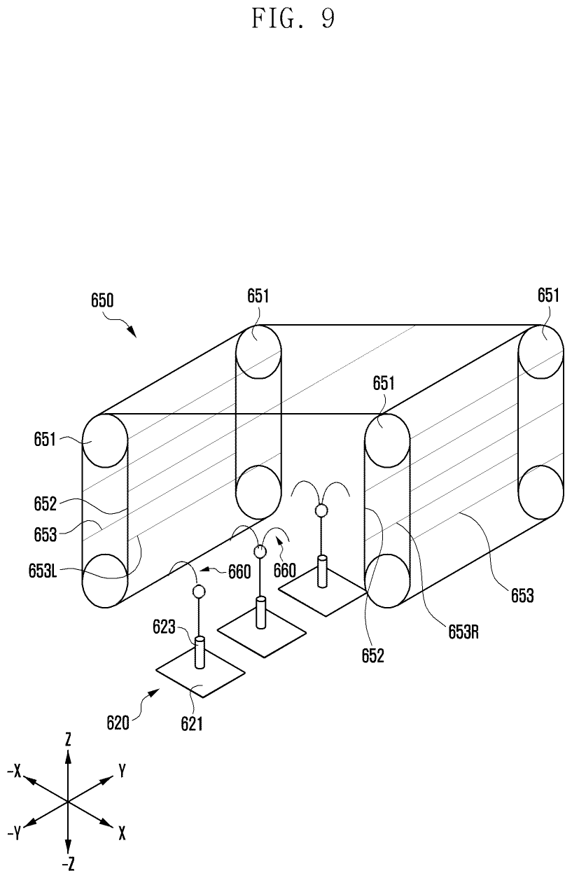

FIG. 9 is a view illustrating an electrode moving device 650 according to an embodiment of the disclosure.

The dielectric heating device 600 (see FIG. 6), according to an embodiment of the disclosure, may include the electrode moving device 650, a catching member 660, and/or a switch (not illustrated). The electrode moving device 650 may be used to move the first unit electrode 611 (see FIG. 6) or the second unit electrode 621 (see FIG. 6) in a height direction (e.g., in the positive z-axis direction) of the dielectric heating device 600 (see FIG. 6) or in a direction opposite to the height direction.

In describing the electrode moving device 650 according to an embodiment of the disclosure, a longitudinal direction of the electrode moving device may mean the positive y-axis direction, and a wide direction thereof may mean the x-axis direction. A height direction of the electrode moving device 650 may mean the positive z-axis direction.

The electrode moving device 650, according to an embodiment of the disclosure, may include a rotation device 651, a connection member 652, and/or a catching region 653.

The electrode moving device 650 according to an embodiment of the disclosure may include a plurality of rotation devices 651. The rotation device 651 may include a motor to generate a rotational motion.

According to an embodiment of the disclosure, the connection member 652 may be connected, at least in part, to the rotation device 651. The connection member 652 may be formed to extend in the height direction of the electrode moving device 650.

In an embodiment of the disclosure, the connection member 652 may convert the rotational motion generated by the rotation device 651 into a linear motion. For example, the connection member 652 may be moved in the height direction of the electrode moving device 650 and in the direction opposite to the height direction.

The electrode moving device 650 according to an embodiment of the disclosure may include a plurality of catching regions 653. Each of the plurality of catching regions 653 may be connected to the connection member 652 and extend in a direction perpendicular to the connection member 652. For example, each of the plurality of catching regions 653 may be formed to extend in the longitudinal direction (e.g., the positive y-axis direction) of the electrode moving device 650. The plurality of catching regions 653 may be each arranged at intervals in the height direction of the electrode moving device 650 (e.g., in the positive z-axis direction).

In an embodiment of the disclosure, the connection member 652 may be moved in the height direction of the electrode moving device 650 and in the direction opposite to the height direction, and the catching region 653 connected to the connection member 652 may be moved in the height direction of the electrode moving device 650 and in the direction opposite to the height direction.

The electrode moving device 650 according to an embodiment of the disclosure may include two rotation devices 651. The two rotation devices 651 may rotate in opposite directions.

In an embodiment of the disclosure, as the two rotation devices 651 rotate in opposite directions, a portion of the electrode moving device 650 may be moved in the height direction of the electrode moving device 650, and a remaining portion may be moved in the direction opposite to the height direction of the electrode moving device 650. For example, a catching region 653L positioned on one side of the electrode moving device 650 may be moved in the height direction of the electrode moving device 650. A catching region 653R positioned on the other side of the electrode moving device 650 may be moved in the direction opposite to the height direction of the electrode moving device 650.

In an embodiment of the disclosure, the catching member 660 may be connected to the second unit electrode 621. For example, the second unit electrode 621 may be connected to the catching member 660 at least in part.

In an embodiment of the disclosure, the electronic device 101 may include a plurality of catching members 660. Each of the plurality of catching members 660 may be connected to the plurality of second unit electrodes 621.

In an embodiment of the disclosure, the catching member 660 may include a hook shape at least in part.

In an embodiment of the disclosure, each of the plurality of second unit electrodes 621 may be connected to the electrode moving device 650 using the catching member 660. For example, at least a portion of the catching member 660 may be seated in the catching region 653 of the electrode moving device 650 and the second unit electrode 621 and the electrode moving device 650 may be connected.

In an embodiment of the disclosure, a position of the catching region 653 in which the catching member 660 is seated may be determined by a state of the switch (not illustrated) included in the electrode moving device 650.

In an embodiment of the disclosure, when the switch (not illustrated) is in an ON state, the catching member 660 connected to the second unit electrode 621 may be seated in the catching region 653L positioned at one side of the electrode moving device 650. Since the catching region 653L positioned on one side of the electrode moving device 650 may be moved in the height direction of the electrode moving device 650, the second unit electrode 621 connected to the catching member 660 may also be moved in the height direction.

In an embodiment of the disclosure, when the switch is in an OFF state, the catching member 660 connected to the second unit electrode 621 may be seated in the catching region 653R positioned on the other side of the electrode moving device 650. Since the catching region 653R positioned at the other end of the electrode moving device 650 may be moved in the direction opposite to the height direction of the electrode moving device 650, the second unit electrode 621 connected to the catching member 660 may also be moved in the direction opposite to the height direction.

In an embodiment of the disclosure, the electronic device 101 may, under the control of the processor 120, switch the switch to an ON/OFF state. For example, in order to move the second unit electrode 621 in the height direction of the electrode moving device 650, the electronic device 101 may, under the control of the processor 120, switch the switch to the ON state. In order to move the second unit electrode 621 in the direction opposite to the height direction of the electrode moving device 650, the electronic device 101 may, under the control of the processor 120, switch the switch to the OFF state.

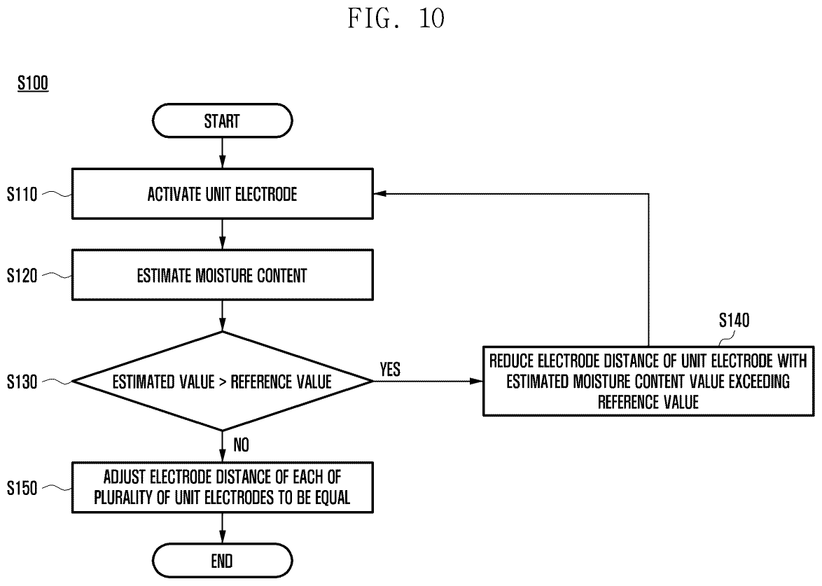

FIG. 10 is a flowchart illustrating a method S100 of operating the electronic device 101 that includes the dielectric heating device 600 according to an embodiment of the disclosure.

Referring to FIG. 10, a method S100 of operation of the electronic device 101 that includes the dielectric heating device 600 according to an embodiment of the disclosure may include, an operation 8110 of activating the plurality of unit electrodes 611 and 621 included in the dielectric heating device 600, an operation S120 of estimating a moisture content of a partial region of the object D to be heated arranged in each of the plurality of unit electrodes 611 and 621, respectively, an operation S130 of comparing the estimated moisture content value of the partial region of the object D to be heated to a predetermined reference value, an operation S140 of reducing a distance formed by the unit electrode 611 or 621, on which the partial region of the object D to be heated with the estimated moisture content value exceeding the reference value is arranged, with a counter electrode, and/or an operation S150 of adjusting the distances between the plurality of unit electrodes 611 and 621 and the counter electrodes to be equal.

At operation S110, the electronic device 101 may, under the control of the processor 120, activate each of the plurality of unit electrodes 611 and 621 included in the dielectric heating device 600. The activation of the unit electrodes 611 and 621 may mean an operation of moving the unit electrodes 611 and 621 toward the object D to be heated and heating the object D to be heated.

In an embodiment of the disclosure, the plurality of unit electrodes 611 and 621 may be the first unit electrode 611 or the second unit electrode 621. At operation S110, the first unit electrode 611 of the dielectric heating device 600 may be activated or the second unit electrode 621 of the dielectric heating device 600 may be activated.

At operation S110, the electronic device 101, under the control of the processor 120, may move the plurality of unit electrodes 611 and 621 in a direction toward the object D to be heated and heat the object D to be heated arranged between the first electrode 610 and the second electrode 620. For example, the plurality of second unit electrodes 621 may be moved in the direction toward the object D to be heated, and the object D to be heated may be heated.

At operation S110, the electronic device 101, under the control of the processor 120, may sequentially activate the unit electrodes 611 and 621 along the longitudinal direction of the dielectric heating device 600 (e.g., the positive x-axis direction, see FIG. 6) to heat the object D to be heated, which is arranged adjacent to the unit electrodes 611 and 621. For example, the plurality of second unit electrodes 621 may be activated sequentially along the longitudinal direction of the dielectric heating device 600.

At operation S110, the electronic device 101 may, under the control of the processor 120, heat the object D to be heated for a predetermined period of time.

At operation S120, the electronic device 101 may, under the control of the processor 120, estimate the moisture content of the partial region of the object D to be heated that is arranged on each of the plurality of unit electrodes 611 and 621.

In an embodiment of the disclosure, the object D to be heated may include a partial region of a plurality of objects D to be heated. The object D to be heated may be divided into a plurality of partial regions of the object D to be heated with respect to a boundary between the respective unit electrodes 611 and 621. The partial region of the object D to be heated may mean some region of the object D to be heated that is arranged adjacent to the respective unit electrodes 611 and 621.

In an embodiment of the disclosure, the moisture content of the partial region of the object D to be heated may be estimated based on an impedance value between the first electrode 610 and the second electrode 620.

In an embodiment of the disclosure, the counter electrode may mean an electrode positioned on an opposite side of one electrode and carrying an opposite charge. For example, the counter electrode of the second electrode 620 and the second unit electrode 621 may mean the first electrode 610.

In an embodiment of the disclosure, the impedance value between the first electrode 610 and the second electrode 620 may mean an impedance value between the unit electrode 611 or 621 and the counter electrode 620 or 610. For example, when the first electrode 610 includes the plurality of first unit electrodes 611, the impedance value may mean a plurality of impedance values between the plurality of first unit electrodes 611 and the second electrode 620. When the second electrode 620 includes the plurality of second unit electrodes 621, the impedance value may mean a plurality of impedance values between the plurality of second unit electrodes 621 and the first electrode 610.

At operation S120, the electronic device 101, under the control of the processor 120, may estimate the moisture content of the object D to be heated through a difference between a reference impedance value and a measured impedance value. For example, the electronic device 101 may, under the control of the processor 120, estimate the moisture content that the object D to be heated has in the measured impedance value based on the moisture content that the object D to be heated has in the reference impedance value.

In an embodiment of the disclosure, the reference impedance value may be an impedance value when the object D to be heated, which has no moisture content or a moisture content value that is equal to or less than a predetermined reference, is arranged between the first electrode 610 and the second electrode 620. The measured impedance value may be an impedance value that is measured when the object D to be heated is arranged between the first electrode 610 and the second electrode 620 of the dielectric heating device 600.

At operation S120, the electronic device 101, under the control of the processor 120, may estimate the moisture content of the object D to be heated based on a weight of the object D to be heated arranged between the first electrode 610 and the second electrode 620.

In an embodiment of the disclosure, the first electrode 610 and the second electrode 620 may include a sensor capable of detecting the weight. For example, each of the plurality of second unit electrodes 620 may include a sensor capable of detecting the weight on the protrusion 623 (see FIG. 8).

At operation S120, the electronic device 101, under control of the processor 120, may estimate the moisture content of the object D to be heated based on a temperature of the object D to be heated arranged between the first electrode 610 and the second electrode 620.

In an embodiment of the disclosure, the first electrode 610 or the second electrode 620 may include an infrared sensor capable of sensing the temperature. For example, each of the plurality of second unit electrodes 620 may include an infrared sensor capable of detecting the temperature.

At operation S130, the electronic device 101 may, under the control of the processor 120, compare the estimated moisture content value of the partial region of the object D to be heated to a predetermined reference value.

At operation S120, the moisture content of the partial region of the object D to be heated that is arranged on each of the plurality of unit electrodes 611 and 621 may be estimated. For example, the moisture content of the partial region of the object D to be heated that is arranged on each of the second unit electrodes 621 may be estimated, respectively.

In an embodiment of the disclosure, the reference value compared to the estimated moisture content value may be an absolute value that is predetermined before the electronic device 101 is operated. For example, the reference value may be an appropriate moisture content value that is determined based on the reference impedance value.

In an embodiment of the disclosure, the appropriate moisture content value may be predetermined based on the moisture content of the object D to be heated having the reference impedance value. For example, the moisture content that the object D to be heated has may be determined as the appropriate moisture content value at an impedance value that differs from the reference impedance value by a predetermined magnitude.

At operation S130, the electronic device 101 may, under the control of the processor 120, compare the moisture content of the partial region of the object D to be heated to the reference value (e.g., a predetermined appropriate moisture content value).

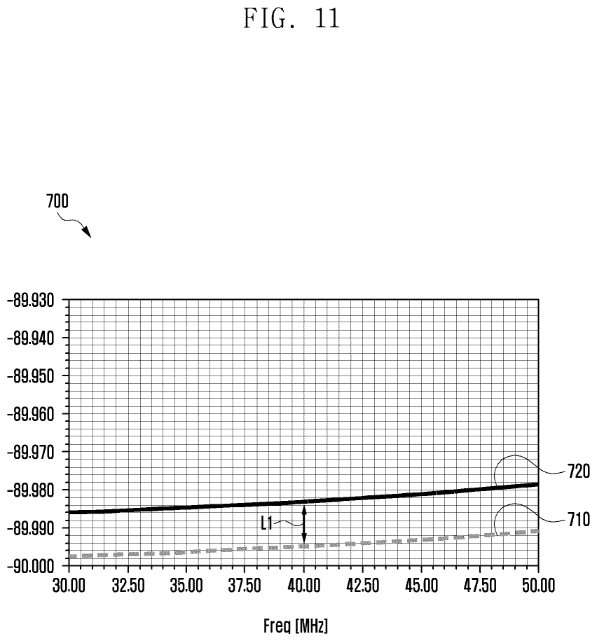

In an embodiment of the disclosure, the appropriate moisture content value may be determined based on a reference impedance phase 710 (see FIG. 11). For example, the moisture content that the object D to be heated has may be determined as the appropriate moisture content value at an impedance phase that differs from the reference impedance phase 710 (see FIG. 11) by a predetermined magnitude.

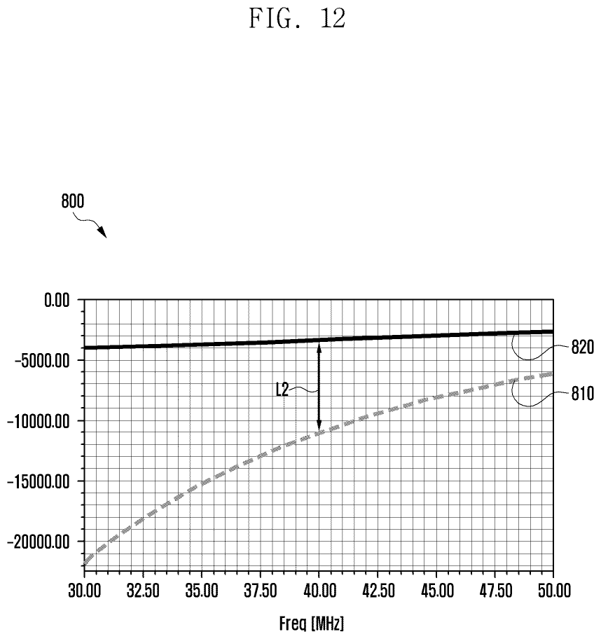

In an embodiment of the disclosure, the appropriate moisture content value may be determined based on a reference impedance ratio 810 (see FIG. 12). For example, the moisture content that the object D to be heated has may be determined as the appropriate moisture content value at an impedance ratio that differs from the reference impedance ratio 810 (see FIG. 12) by a predetermined magnitude.

In an embodiment of the disclosure, the reference value compared to the estimated moisture content value may be a relative value that is determined while the electronic device 101 is at operation. The reference value may be determined based on a moisture content distribution of the partial region of the object D to be heated estimated at operation S120. For example, the reference value may be determined as a moisture content value of a region with the smallest moisture content among the partial regions of the object D to be heated, or as a median of the moisture content distribution of the entire partial regions of the object D to be heated.

At operation S130, the electronic device 101 may, under the control of the processor 120, compare the moisture content of the partial region of the object D to be heated to a relatively predetermined reference value. For example, at operation S130, the electronic device 101, under the control of the processor 120, may compare a moisture content of a partial region of the object D to be heated, which is subject to be compared, to a moisture content value of a region having the smallest moisture content among the partial regions of the object D to be heated.

At operation S140, the electronic device 101, under the control of the processor 120, may reduce an electrode distance of the unit electrodes 611 and 621 for which the estimated moisture content value exceeds the reference value at operation S130.

In an embodiment of the disclosure, the electrode distance of the unit electrodes 611 and 621 may mean a distance formed by the unit electrode 611 or 621 with the counter electrode 620 or 610. For example, the electrode distance of the second unit electrode 621 may mean a linear distance from the second unit electrode 621 to the first electrode 610.

At operation S130, when an estimated moisture content value of at least one partial region of the object D to be heated exceeds the reference value, at operation S140, the electronic device 101 may, under the control of the processor 120, reduce the electrode distance of the unit electrodes 611 and 621 on which the partial region of the object D to be heated with the estimated moisture content value exceeding the reference value is arranged.

In an embodiment of the disclosure, since the intensity of the electric field is formed stronger for the unit electrodes 611 and 621 with reduced electrode distance compared to the remaining unit electrodes, the object D to be heated may be heated relatively strongly.

The electronic device 101, which has performed operation S140, may, under the control of the processor 120, return back to operation S110 to activate the unit electrodes 611 and 621. For example, at operation S110, the electronic device 101 may, under the control of the processor 120, reheat the object D to be heated for a predetermined period of time using the unit electrodes 611 and 621 with a reduced electrode distance and the remaining unit electrodes 611 and 621 with an unchanged electrode distance.

At operation S150, the electronic device 101 may, under the control of the processor 120, adjust the electrode distances of the plurality of unit electrodes 611 and 621 to be equal.

At operation S130, when the estimated moisture content values of all partial regions of the object D to be heated are determined to be equal to or less than the reference value, operation S150 may be performed.

At operation S150, the electronic device 101 may, under the control of the processor 120, adjust the electrode distance of each of the plurality of unit electrodes 611 and 621 to be equal. For example, the linear distances from the second unit electrodes 621 to the first electrode 610 may be adjusted to be equal.

In an embodiment of the disclosure, when the electrode distances of the plurality of unit electrodes 611 and 621 are adjusted to be equal, each partial region of the object D to be heated may be heated evenly.

FIG. 11 is a graph illustrating a reference impedance phase 710 and a measured impedance phase 720 according to an embodiment of the disclosure.

A graph 700 exemplarily illustrates a change in the reference impedance phase 710 and the measured impedance phase 720 in the dielectric heating device 600 illustrated in FIG. 6.

In the graph 700, a horizontal axis may mean an operating frequency of the dielectric heating device 600, and a vertical axis may mean an impedance phase.

In an embodiment of the disclosure, an impedance may include a real part determined by a resistor value and an imaginary part determined by a capacitor value and a coil value.

In an embodiment of the disclosure, the impedance may be represented as a vector expressed as coordinates of real and imaginary parts on a complex plane having an x-axis and a y-axis. For example, a value in the real part may mean a value on the x-axis in the complex plane, and a value in the imaginary part may mean a value on the y-axis in the complex plane. An impedance phase may mean an angle formed by the impedance vector in the complex plane with the x-axis in the complex plane.

In an embodiment of the disclosure, the reference impedance phase 710 may mean a phase that a reference impedance has. The reference impedance may be an impedance when the object D to be heated, which has no moisture content or a moisture content value that is equal to or less than a determined reference, is arranged between the first electrode 610 and the second electrode 620.

In an embodiment of the disclosure, the measured impedance phase 720 may be an impedance phase that is measured when the object D to be heated is arranged between the first electrode 610 and the second electrode 620 of the dielectric heating device 600.

Referring to FIG. 11, a difference may appear between the reference impedance phase 710 and the measured impedance phase 720 at a determined frequency. For example, there may be a difference between the reference impedance phase 710 and the measured impedance phase 720 at a frequency of 40 MHz by a first length L1.

At operation S120, the electronic device 101 may, under the control of the processor 120, estimate the moisture content of the object D to be heated based on the difference between the reference impedance phase 710 and the measured impedance phase 720 (e.g., the first length L1).

FIG. 12 is a graph illustrating the reference impedance ratio 810 and a measured impedance ratio according to an embodiment of the disclosure.

A graph 800 exemplarily illustrates a change in the reference impedance ratio 810 and a measured impedance ratio 820 in the dielectric heating device 600 illustrated in FIG. 6.

In the graph 800, a horizontal axis may mean an operating frequency of the dielectric heating device 600, and a vertical axis may mean an impedance ratio.

In an embodiment of the disclosure, an impedance may include a real part determined by a resistor value and an imaginary part determined by a capacitor value and a coil value.

In an embodiment of the disclosure, an impedance ratio may mean a value of the imaginary part of the impedance divided by a value of the real part of the impedance.

In an embodiment of the disclosure, the reference impedance ratio 810 may mean an impedance ratio that a reference impedance has. The reference impedance may be an impedance when the object D to be heated, which has no moisture content or a moisture content value that is equal to or less than a determined reference, is arranged between the first electrode 610 and the second electrode 620.

In an embodiment of the disclosure, the measured impedance ratio 820 may be an impedance ratio that is measured when the object D to be heated is arranged between the first electrode 610 and the second electrode 620 of the dielectric heating device 600.

Referring to FIG. 12, a difference may appear between the reference impedance ratio 810 and the measured impedance ratio 820 at a determined frequency. For example, there may be a difference between the reference impedance ratio 810 and the measured impedance ratio 820 at a frequency of 40 MHz by a second length L2.

At operation S120, the electronic device 101 may, under the control of the processor 120, estimate the moisture content of the object D to be heated based on the difference between the reference impedance ratio 810 and the measured impedance ratio 820 (e.g., the second length L2).

An electronic device according to an embodiment of the disclosure may be one of various types of electronic devices. The electronic device may include, for example, a portable communication device (e.g., a smartphone), a computer device, a portable multimedia device, a portable medical device, a camera, a wearable device, or a home appliance. The electronic device according to the embodiment of the disclosure is not limited to the above-mentioned devices.

An embodiment of the disclosure and the terms used in the embodiment are not intended to limit the technical features disclosed in the disclosure to the particular embodiments and should be understood as including various alterations, equivalents, or alternatives of the corresponding embodiments. In connection with the description of the drawings, the same or similar reference numerals may be used for the similar components. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. Such terms as “1st” and “2nd,” or “first” and “second” may be used to simply distinguish a corresponding component from another, and does not limit the components in other aspect (e.g., importance or order). If an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

The term “module” used in an embodiment of the disclosure may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to the embodiment of the disclosure, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke and execute at least one of the one or more instructions stored in the storage medium. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments disclosed in the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PLAYSTORE™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment of the disclosure, each constituent element (e.g., module or program), among the above-mentioned constituent elements, may include a single object or a plurality of objects, and some of the plurality of objects may be disposed separately in different constituent elements. According to an embodiment of the disclosure, one or more constituent elements, among the above-mentioned constituent elements, or operations may be omitted, or one or more other constituent elements or operations may be added. Alternatively or additionally, a plurality of components (e.g., modules or programs) may be integrated into a single component. In this case, the integrated component may perform one or more functions of each of the plurality of components in the same or similar manner as they are performed by a corresponding one of the plurality of components before the integration.

According to an embodiment of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a power source;
memory storing one or more computer programs;
a dielectric heating device; and
one or more processors communicatively coupled to the power source, the memory, and the dielectric heating device,
wherein the dielectric heating device includes:
a first electrode connected to the power source, and
a second electrode connected to the power source and arranged to be spaced apart from the first electrode in a direction away from one surface of the first electrode,
wherein the second electrode includes a plurality of second unit electrodes each arranged at intervals in a longitudinal direction and a width direction,
wherein the dielectric heating device heats an object to be heated arranged between the first electrode and the second electrode, and
wherein the one or more computer programs include computer-executable instructions that, when executed by the one or more processors individually or collectively, cause the electronic device to determine an electrode distance, which is a linear distance between the first electrode and the second unit electrode, based on an estimated moisture content value of a partial region of the object being heated arranged on each of the second unit electrodes.

2. The electronic device of claim 1, wherein the one or more computer programs further include computer-executable instructions that, when executed by the one or more processors individually or collectively, cause the electronic device to reduce an electrode distance of the second unit electrode on which a partial region of the object to be heated with the estimated moisture content value exceeding a reference value is arranged.

3. The electronic device of claim 1, wherein the one or more computer programs further include computer-executable instructions that, when executed by the one or more processors individually or collectively, cause the electronic device to estimate a moisture content of a partial region of the object to be heated arranged on each of the second unit electrodes based on an impedance value between the first electrode and the second unit electrode.

4. The electronic device of claim 3, wherein the one or more computer programs further include computer-executable instructions that, when executed by the one or more processors individually or collectively, cause the electronic device to estimate the moisture content of the partial region of the object to be heated arranged on each of the second unit electrodes based on a ratio of a real part of the impedance value to an imaginary part of the impedance value.

5. The electronic device of claim 1,
wherein each of the plurality of second unit electrodes includes a weight sensor, and
wherein the one or more computer programs further include computer-executable instructions that, when executed by the one or more processors individually or collectively, cause the electronic device to estimate a moisture content of a partial region of the object to be heated arranged on each of the second unit electrodes based on a weight of a partial region of the object to be heated measured by the weight sensor.

6. The electronic device of claim 1,
wherein each of the plurality of second unit electrodes includes an infrared sensor, and
wherein the one or more computer programs further include computer-executable instructions that, when executed by the one or more processors individually or collectively, cause the electronic device to estimate a moisture content of a partial region of the object to be heated arranged on each of the second unit electrodes based on a temperature of a partial region of the object to be heated measured by the infrared sensor.

7. The electronic device of claim 1,
wherein each of the plurality of second unit electrodes rotates about a center point positioned at a center in a longitudinal direction of the second unit electrode, and
wherein the one or more computer programs further include computer-executable instructions that, when executed by the one or more processors individually or collectively, cause the electronic device to allow the second unit electrode, on which a partial region of the object to be heated with the estimated moisture content value exceeding a reference value is arranged, to rotate.

8. The electronic device of claim 1, further comprising:
a plate,
wherein the plurality of second unit electrodes are arranged on one surface of the plate.

9. The electronic device of claim 1, further comprising:
an electrode moving device; and
a plurality of catching members each connected with the plurality of second unit electrodes,
wherein the electrode moving device includes:
a rotation device configured to generate a rotational motion,
a connecting member connected to the rotating device at least in part, configured to convert the rotational motion of the rotating device into a linear motion, and extending in a height direction, and
a plurality of catching regions arranged at intervals in the height direction of the electrode moving device, and extending perpendicular to the connection member,
wherein a portion of the electrode moving device is moved in the height direction, and a remaining portion of the electrode moving device is moved in a direction opposite to the height direction, and
wherein the plurality of second unit electrodes are connected to and moved with the electrode moving device using the catching member seated in the catching region.

10. A method of operating an electronic device, which includes a dielectric heating device, the method comprising:
activating a plurality of unit electrodes to heat an object to be heated;
estimating a moisture content of a partial region of the object to be heated arranged on each of the plurality of unit electrodes;
comparing an estimated moisture content value of the partial region of the object to be heated to a reference value;
reducing a distance formed by the unit electrode, on which a partial region of the object to be heated with the estimated moisture content value exceeding the reference value is arranged, with a counter electrode when the estimated moisture content value exceeds the reference value in at least one partial region of the object to be heated; and
adjusting a distance formed by each of the plurality of unit electrodes with the counter electrode to be equal when the estimated moisture content value in all the partial regions of the object to be heated is equal to or less than the reference value.

11. The method of claim 10, wherein the moisture content of the partial region of the object to be heated arranged on each of the plurality of unit electrodes is estimated based on an impedance value between the plurality of unit electrodes and the counter electrode.

12. The method of claim 10, wherein the moisture content of the partial region of the object to be heated arranged on each of the plurality of unit electrodes is estimated based on a weight of the partial region of the object to be heated.

13. The method of claim 10, wherein the moisture content of the partial region of the object to be heated arranged on each of the plurality of unit electrodes is estimated based on a temperature of the partial region of the object to be heated.

14. The method of claim 10, wherein each of the plurality of unit electrodes rotates about a center point positioned at a center in a longitudinal direction of the plurality of unit electrodes.

15. The method of claim 10, wherein the electronic device further includes:
an electrode moving device; and
a plurality of catching members each connected with the plurality of unit electrodes,
wherein the electrode moving device includes:
a rotation device configured to generate a rotational motion,
a connecting member connected to the rotating device at least in part, configured to convert the rotational motion of the rotating device into a linear motion, and extending in a height direction, and
a plurality of catching regions arranged at intervals in the height direction of the electrode moving device, and extending perpendicular to the connection member,
wherein a portion of the electrode moving device is moved in the height direction, and a remaining portion of the electrode moving device is moved in a direction opposite to the height direction, and
wherein the plurality of unit electrodes are connected to and moved with the electrode moving device using the catching member seated in the catching region.

16. The method of claim 15, further comprising:
arranging the plurality of unit electrodes on one surface of a plate of the electronic device.

17. The method of claim 15, further comprising:
connecting each of a plurality of catching members with the plurality of unit electrodes.

18. The method of claim 17, further comprising:
moving a portion of the electrode moving device in a height direction of the electrode moving device;
moving a remaining portion of the electrode moving device in a direction opposite to the height direction; and
connecting the plurality of unit electrodes to the electrode moving device using the catching member seated in the catching region.

19. One or more non-transitory computer-readable storage media storing computer-executable instructions that, when executed by one or more processors individually or collectively, cause an electronic device, which includes a dielectric heating device, to perform operations, the operations comprising:
activating a plurality of unit electrodes to heat an object to be heated;
estimating a moisture content of a partial region of the object to be heated arranged on each of the plurality of unit electrodes;
comparing an estimated moisture content value of the partial region of the object to be heated to a reference value;
reducing a distance formed by the unit electrode, on which a partial region of the object to be heated with the estimated moisture content value exceeding the reference value is arranged, with a counter electrode when the estimated moisture content value exceeds the reference value in at least one partial region of the object to be heated; and
adjusting a distance formed by each of the plurality of unit electrodes with the counter electrode to be equal when the estimated moisture content value in all the partial regions of the object to be heated is equal to or less than the reference value.

20. The one or more non-transitory computer-readable storage media of claim 19, wherein the moisture content of the partial region of the object to be heated arranged on each of the plurality of unit electrodes is estimated based on an impedance value between the plurality of unit electrodes and the counter electrode.
